(19) United States
(12) Patent Application Publication
(10) Pub. No.: US 2008/0147493 A1
(43) Pub. Date: Jun. 19, 2008

(54) AD PRESENTMENT IN A MOBILE DEVICE

(76) Inventors: Ari Aarnio, Espoo (FI); Mikko Saarisalo, Kantvik (FI); Jukka-Pekka Raisanen, Laukaa (FI); Jarkko Sevanto, Vantaa (FI)

Correspondence Address: PERMAN & GREEN, 425 POST ROAD, FAIRFIELD, CT, 06824, US

(21) Appl. No.: 11/551,766

(22) Filed: Oct. 23, 2006

(51) Int. Cl. G07G 1/14

(52) U.S. Cl. 705/14

(57) ABSTRACT

A method including displaying at least one user interface feature on a display, receiving at least a first information related to at least one advertisement and displaying the at least first information related to the at least one advertisement in place of at least one of the at least one user interface feature when the at least one user interface feature is visible on the display.

### BACKGROUND

1. Field

The present embodiments relate to advertising and, more particularly, to advertising in a mobile device.

2. Brief Description of Related Developments

Advertisements may be sent to a mobile device such as a mobile communication terminal as, for example, short message service (SMS) or multimedia message service (MMS) messages. A network operator or advertiser may include a reply phone number and/or forwarding web link into the message so that the user may respond to the ad when the ad is opened. However, when advertisements are sent to the mobile device via SMSI MMS or other type of message there is no guarantee that a user of the device will read or even look at the ads. There is also very little user interaction with the SMS or MMS advertising messages even though the phone number and/or forwarding web link are added into both message types.

Advertisements that are downloaded for display as a background on a display of the device or as screen savers may also been known but are not widely deployed.

There is a need to display an advertisement so that the advertisement is presented to the user during normal operation of the mobile device in such a way so the user is not frustrated by the presentment of the advertisement.

### SUMMARY

In one embodiment, a method is provided. The method includes displaying at least one user interface feature on a display, receiving at least a first information related to at least one advertisement and displaying the at least first information related to the at least one advertisement in place of at least one of the at least one user interface feature when the at least one user interface feature is visible on the display.

In one embodiment, an apparatus is provided. The apparatus includes a display configured to display at least one user interface feature, a receiver configured to receive at least a first information related to at least one advertisement and a processor configured to display the at least first information related to the at least one advertisement in place of at least one of the at least one user interface feature when the at least one user interface feature is visible on the display.

In another embodiment, a computer program product is provided. The computer program product includes a computer useable medium having computer readable code means embodied therein for causing a computer to display at least a first information related to at least one advertisement. The computer readable code means in the computer program product includes computer readable code means for causing a computer to display at least one user interface feature on a display, computer readable code means for causing a computer to receive at least a first information related to at least one advertisement and computer readable code means for causing a computer to display the at least first information related to the at least one advertisement in place of at least one of the at least one user interface feature when the at least one user interface feature is visible on the display.

### BRIEF DESCRIPTION OF THE DRAWINGS

The foregoing aspects and other features of the present embodiments are explained in the following description, taken in connection with the accompanying drawings, wherein:

FIG. 1 shows a schematic illustration of a communication system, as an example in which aspects of the invention may be applied;

FIG. 2 shows a device incorporating features of an embodiment;

FIG. 3 shows another device incorporating features of an embodiment;

FIG. 4 illustrates yet another device incorporating features of an embodiment;

FIG. 5 shows an advertisement in accordance with an embodiment;

FIG. 6 illustrates a flow diagram in accordance with an embodiment;

FIG. 7 illustrates a table in accordance with an embodiment;

FIG. 8A illustrates a schematic view device features in accordance with an embodiment;

FIG. 8B shows a flow diagram in accordance with an embodiment;

FIG. 9 illustrates a schematic representation of messages in accordance with an embodiment; and

FIG. 10 shows a block diagram of one embodiment of a typical apparatus incorporating features of the aspects of the invention that may be used to practice the aspects of the invention.

### DETAILED DESCRIPTION OF THE EXEMPLARY EMBODIMENT(s)

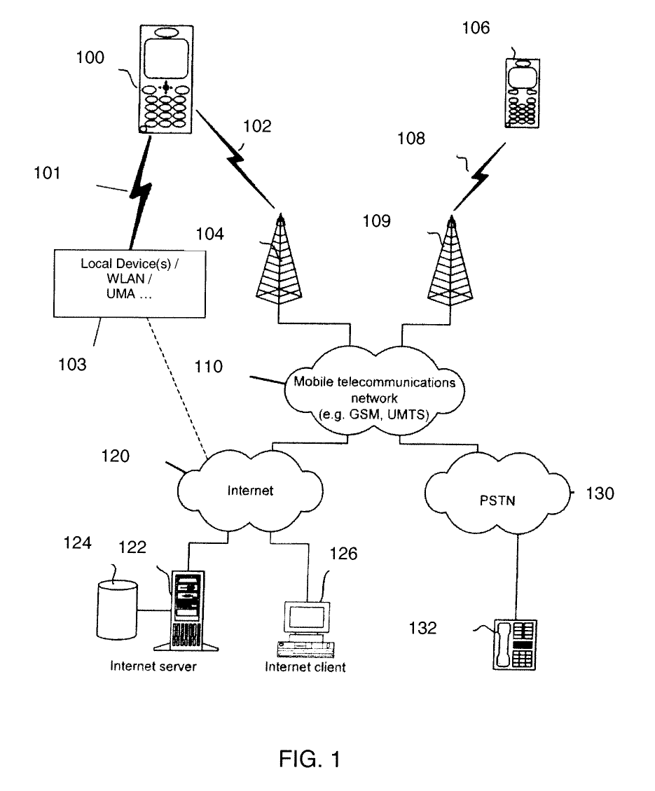

FIG. 1 is a schematic illustration of a telecommunications system, as an example, of an environment in which a communications device 100 incorporating features of an embodiment may be applied. Although aspects of the invention will be described with reference to the embodiments shown in the drawings and described below, it should be understood that these aspects could be embodied in many alternate forms of embodiments. In addition, any suitable size, shape or type of elements or materials could be used.

The number of mobile communication devices in use around the world is ever increasing. As such, mobile communication devices present a significant opportunity for any suitable companies such as advertising companies and the like to present information to a broad range of individuals. Any suitable message or advertising data (i.e. the advertisement) may be sent to the mobile communication devices from any suitable communications interface such as, for example, another mobile device, local devices, or an internet server or internet client. The advertisements may include any suitable informational content such as, for example, items or services for sale, information not related to any type of solicitation, meeting times, public service announcements, employment opportunities and the like. The advertisement may be any suitable advertisement such as advertisements for goods, services and the like. It would be advantageous to provide mobile communication devices and methods for providing the advertisements to users of the mobile devices in such a way so as not to hinder the use of the device. It would also be advantageous to display the advertising information to a user in such a way so the user will be curious as to what information is being presented thereby increasing the efficiency of the advertising.

In the telecommunication system of FIG. 1, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 100 and other devices, such as another mobile terminal 106, a stationary telephone 132, or an internet server 122. It is to be noted that for different embodiments of the mobile terminal 100 and in different situations, different ones of the telecommunications services referred to above may or may not be available. The aspects of the invention are not limited to any particular set of services in this respect.

The mobile terminals 100, 106 may be connected to a mobile telecommunications network 110 through radio frequency (RF) links 102, 108 via base stations 104, 109. The mobile telecommunications network 110 may be in compliance with any commercially available mobile telecommunications standard such as GSM, UMTS, D-AMPS, CDMA2000, FOMA and TD-SCDMA.

The mobile telecommunications network 110 may be operatively connected to a wide area network 120, which may be the internet or a part thereof. An internet server 122 has data storage 124 and is connected to the wide area network 120, as is an internet client computer 126. The server 122 may host a www/hap server capable of serving www/hap content to the mobile terminal 100.

For example, a public switched telephone network (PSTN) 130 may be connected to the mobile telecommunications network 110 in a familiar manner. Various telephone terminals, including the stationary telephone 132, may be connected to the PSTN 130.

The mobile terminal 100 is also capable of communicating locally via a local link 101 to one or more local devices 103. The local link 101 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 103 can, for example, be various sensors that can communicate measurement values to the mobile terminal 100 over the local link 101. The above examples are not intended to be limiting, and any suitable type of link may be utilized. The local devices 103 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 100 may thus have multi-radio capability for connecting wirelessly using mobile communications network 110, WLAN or both. Communication with the mobile telecommunications network 110 may also be implemented using WiFi, WiMax, or any other suitable protocols, and such communication may utilize unlicensed portions of the radio spectrum (e.g. unlicensed mobile access (UMA)).

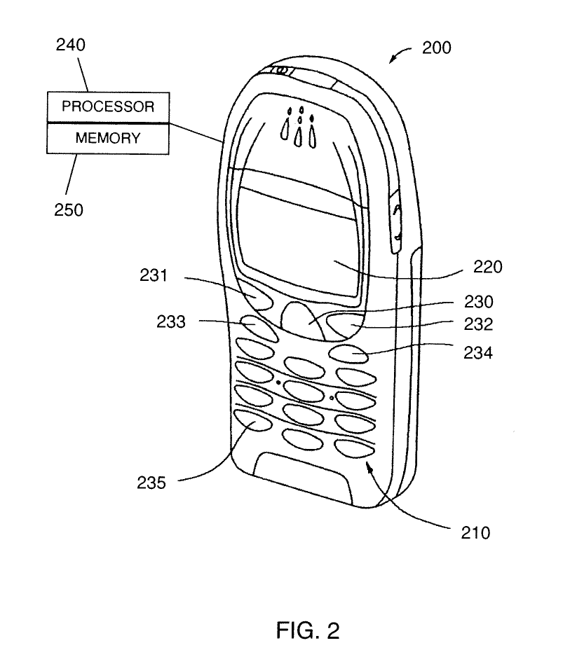

One example of a terminal 100 is illustrated in more detail in FIG. 2. The terminal or mobile communications device 200 may have a keypad 210 and a display 220. The keypad 210 may include any suitable user input devices such as, for example, a multi-function/scroll key 230, soft keys 231, 232, a call key 233 and end call key 234 and alphanumeric keys 235. The display 220 may be any suitable display, such as for example, a touch screen display or graphical user interface. The display may be integral to the device 200 or the display may be a peripheral display connected to the device 200. A pointing device, such as for example, a stylus, pen or simply the user's finger may be used with the display 220. In alternate embodiments any suitable pointing device may be used. In other alternate embodiments, the display may be a conventional display. The device 200 may also include other suitable features such as, for example, a camera, loud speaker, connectivity port or tactile feedback features. The mobile communications device may have a processor 240 connected to the display for processing user inputs and displaying information on the display 220. A memory 250 may be connected to the processor 240 for storing any suitable information and/or applications associated with the mobile communications device 200 such as phone book entries, calendar entries, etc.

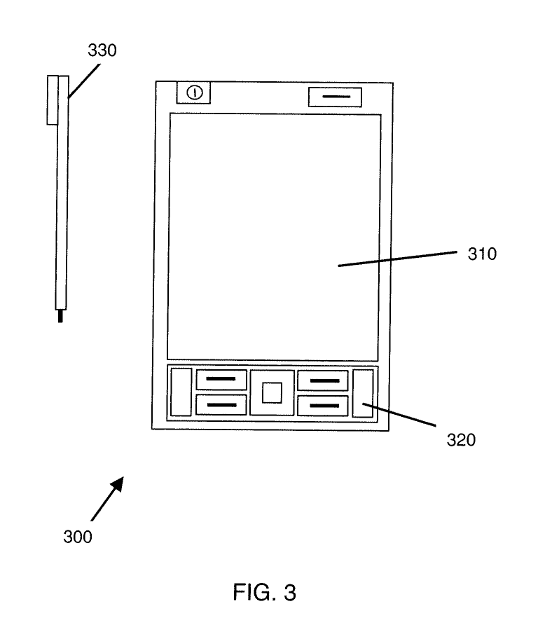

In one example, the device 100, may be for example, a PDA style device 300 illustrated in FIG. 3. The PDA 300 may have a keypad 320, a touch screen display 310 and a pointing device 330 for use on the touch screen display 310. In still other alternate embodiments, the device may be a personal communicator, a tablet computer, a laptop or desktop computer, a television or television set top box or any other suitable device capable of containing the display 220 and supported electronics such as the processor 240 and memory 250. The embodiments herein will be described with reference to the mobile communications device 100 for exemplary purposes only and it should be understood that the embodiments could be applied equally to any suitable device incorporating a display, processor, memory and supporting software or hardware.

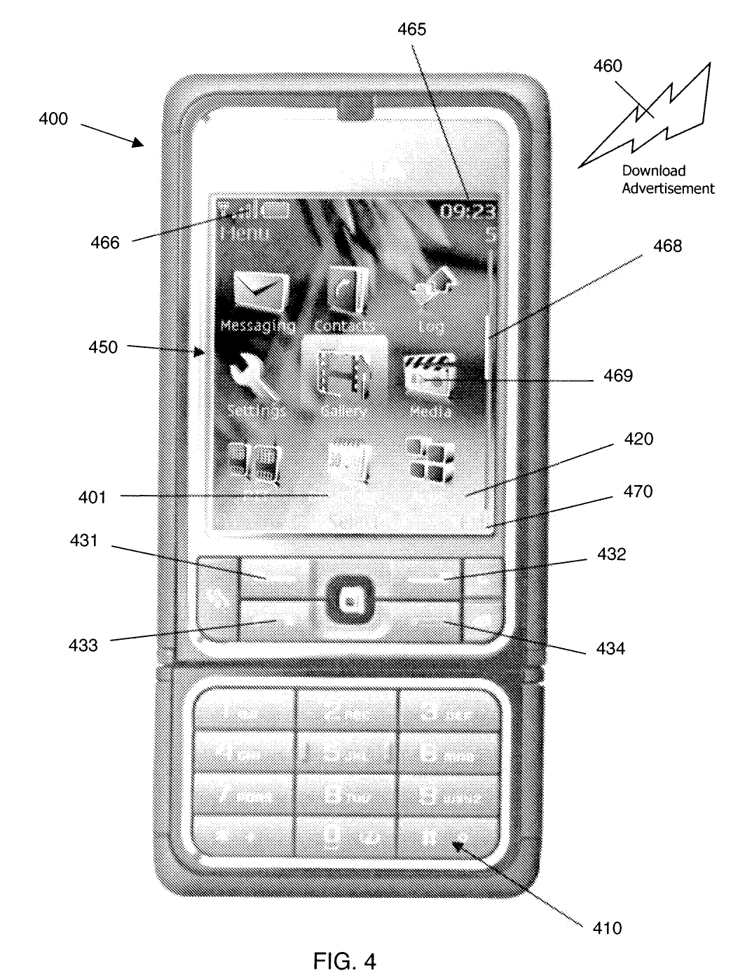

Referring now to FIG. 4, a mobile communications device or terminal 400 is shown. The mobile terminal 400 may be substantially similar to devices 100, 200 described above and may include a display 420 and keypad 410. The keypad 410 may include any suitable user input devices such as, for example, soft keys 431, 432, a call key 433 and end call key 434 and alphanumeric keys. Any suitable display screen may be presented on the display 420. In this example the user interface includes the time 465, signal and battery strength indicators 466, a slide bar 468, soft key functions 470 and icons or links 450 to applications or functions (e.g. music players, internet, television, calendars, etc.) of the mobile terminal. In other alternate embodiments the display screen may have more or less features than those shown in the drawings. It other alternate embodiments the display screen may have any suitable features.

The mobile device 400 may be configured to receive any suitable information related to an advertisement(s) from any suitable source as described above. The mobile terminal 400 may be configured to receive or download 460 the advertisement information or a portion of the advertisement information through for example, any suitable communications protocols such as cellular protocols, internet protocols, SMS, MMS, Bluetooth, infrared, video, digital/analog, etc. Information related to the advertisement(s) may be displayed in any suitable area of the display 420 including, but not limited to, over an icon, text, graphic or symbol located on the display 420, in the background of the display 420 and the like. The information related to the advertisement may include, but is not limited to, an ad identifier or indicator, the advertisement itself, information on which icon or text, if any, the ad will replace on the display and for what duration of time the advertisement will remain visible on the display. Examples pertaining to the display of the advertising information will be described in greater detail below.

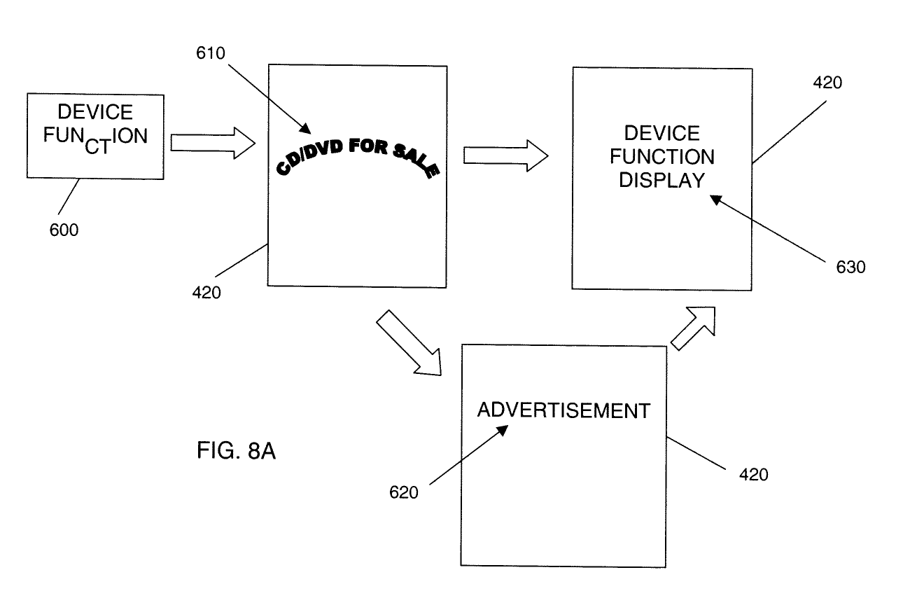

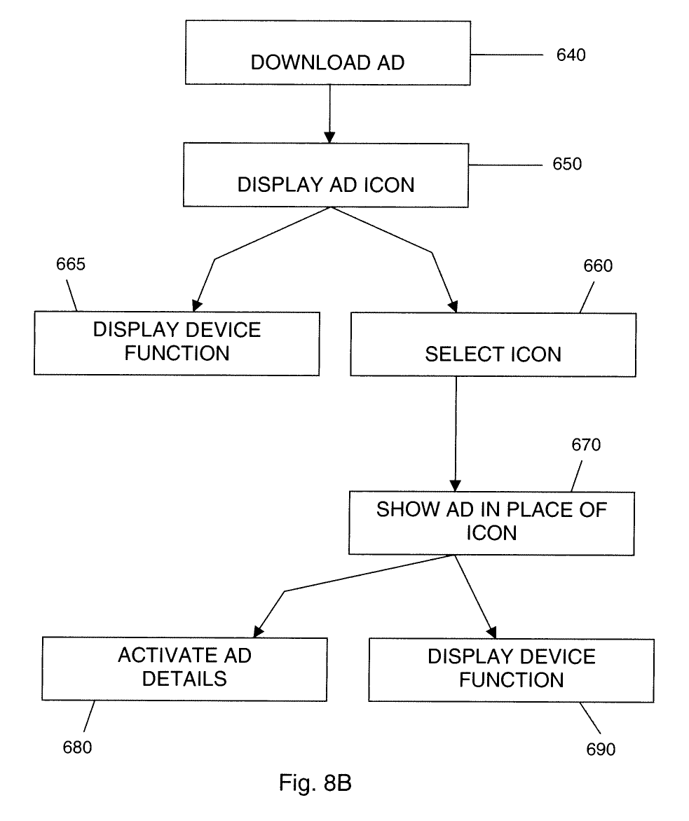

The mobile terminal 400 may be configured to receive or download the advertising information at any suitable time. Examples of when the terminal 400 may receive or download the advertising information include, but are not limited to when the terminal is in use or in an idle state, when the terminal is in an active state (e.g. in use) or upon request from a user of the terminal. The mobile terminal 400 may also be configured to store any suitable number of downloaded advertisements in the memory 250 of the mobile terminal 400 (Block 640, FIG. 8B) for later retrieval and presentment to a user of the mobile terminal 400.

In one embodiment, at least a portion of the advertising information or an indication of the advertising information is downloaded to the device. The background lighting of the display and keys can be used to inform the user that an advertising information has been received in the mobile terminal 400. In another embodiment, the background lighting such as, for example, the back-lighting of the keys on the keypad 410 of the mobile terminal may be turned off while the mobile terminal is inactive and the partial mode advertisement is presented. In still another embodiment the background lighting may be turned on or may flash for a predetermined amount of time to indicate an advertisement has been received and is being displayed over, for example, an icon or text shown in the display 420. In alternate embodiments an audible indicator may sound to alert the user to the receipt of the advertisements in the mobile terminal.

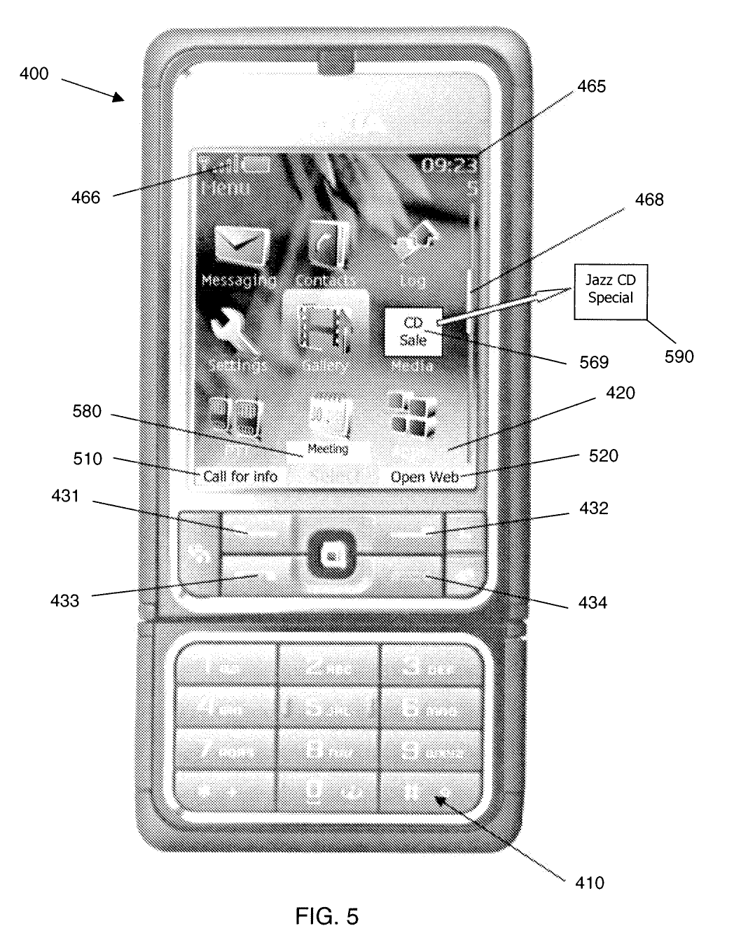

A portion of the advertisement or a descriptive aspect related to the advertisement (e.g. an advertisement indicator) can be displayed or presented to the user. For example, in one embodiment an advertising message is downloaded to the terminal 400 at any suitable time. An indicator of the advertising information may be displayed to the user as shown in FIG. 5. In alternate embodiments, any suitable content related to the advertisement may be displayed to the user, such as for example a more complete version of the advertisement. The advertising content, such as for example, the descriptive aspect or portion of the advertising information may include text, graphics, animations, symbols or any other suitable indicator related to the advertising information. In alternate embodiments, the indicator may be downloaded to the terminal so that when the indicator is selected a more complete version of the advertisement is downloaded.

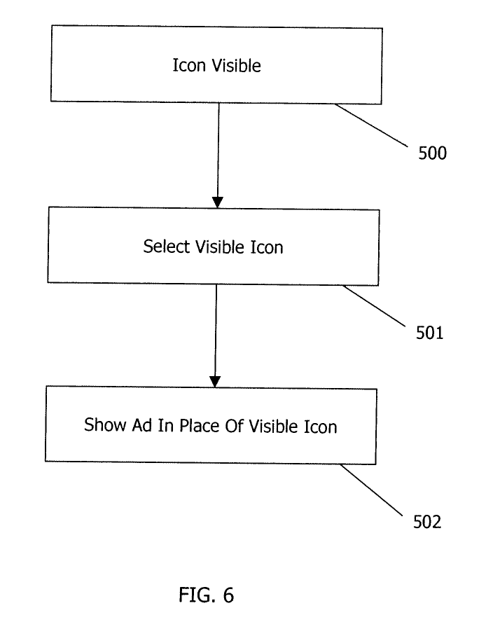

The terminal 400 may include any suitable hardware or software for processing the received or downloaded advertising information for presentment to a user. In one embodiment, the processor 240 may process the downloaded advertisement information and extract information from, for example, any suitable part of the advertising message (e.g. the message header, the body of the message, etc.) for display on the terminal 400. In one embodiment, the advertising information such as the indicator or a more complete version of the advertisement may be displayed by the terminal 400 in any suitable area of the display such as, for example, over a visible feature of the user interface presented on the display 420, in a status bar, as a soft key function and the like. In the example shown in FIG. 5, an indicator of the advertisement 569 is shown over or in place of the icon 469. Additional advertising information 590 may be presented to the user by selecting the advertisement information 569 via any suitable key of the device, a pointing device, a user's finger, etc. The additional advertising information 590 may be presented to the user in any suitable manner, such as for example, by showing the additional advertisement information over the icon 469 or providing the additional advertising information in a different screen shown on the display 420. In another example, also shown in FIG. 5, the advertising information 580 is shown over the text 401 displayed on the display 420. In alternate embodiments, the advertising information may be shown in any suitable location on the display. In other alternate embodiments, the advertising information may be associated with, for example, an icon or text that is not shown on the display. The advertising information may be presented to the user at the time when the associated icon or text appears on the display. For example an icon or text may appear on the display (Block 500, FIG. 6). A user of the terminal 400 may select the visible icon (Block 501, FIG. 6) so that the advertisement is displayed in place of the visible icon (Block 502, FIG. 6). In one embodiment, even though the advertisement is shown in place of the icon, the function of the icon may be maintained so that the advertisement does not hinder the use of the terminal 400. In other embodiments selecting the advertisement may cause further information pertaining to the advertisement to be displayed.

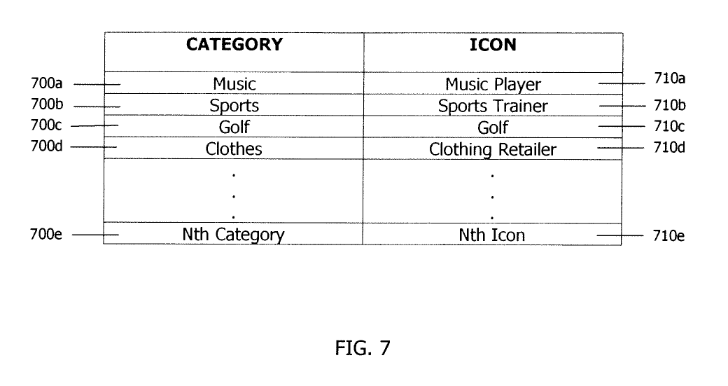

In another embodiment, the advertising messages may be linked to a certain type of device function or application (e.g. advertising directed to a certain market). As can be seen in FIG. 7, the advertisements may be divided according to any suitable number of categories 700a-700e. Each category of advertisement may be associated with a corresponding icon 710a-104e of the terminal 400. In one example, the categories may include music 700a, sports 700b, golf 700c, and clothes 700d. These categories may be associated with a music player icon 710a, a sport trainer icon 710b, a golf icon 710c and a clothing retailer icon 710d respectively. For example, referring to FIG. 5 an advertisement for a music CD may be received in the terminal 400. The advertisement information or information related to the advertising message may be displayed or presented to the user (Block 650, FIG. 8B). The advertisement may be linked to a corresponding device function or application such as, for example, a music player or video player function of the mobile terminal 400. The music player or video player maybe found in the “Media” function of the terminal 400. As shown in FIG. 5, advertising information 569 may be displayed over the “Media” icon. In FIG. 5 an indicator of the advertising content is shown over the icon but in alternate embodiments any suitable content of the advertising information may be displayed. In another example, the advertisement may be related to a meeting that the user is to attend. Here the advertisement information 580 may be placed over the text of the “Organizer” function of the terminal 400.

The advertisement information may be displayed at any suitable time such as when the advertisement is downloaded, the device function or application is activated or upon request by the user. In one example, as shown in FIG. 8A, when the device function 600 is activated, the advertisement information such as indicator 610 informs the user of a CD or DVD that is for sale. The user may also be presented with an option to view additional advertising information 620 relating to the advertising message (Block 660, FIG. 8B). Referring again to FIG. 5, the advertisement options 510, 520 may be presented to the user when the additional information is displayed. The options may be presented to the user in any suitable manner such as through, for example, a key of the terminal 400 or through a touch on a touch screen. The advertisement options may be any suitable options to, for example, obtain more information about the advertisement, contact the advertiser, order the products or services advertised, stop the display of the additional advertising information, etc. The advertisement options 510, 520 may be custom functions pertaining to the advertisement that may be associated with keys of the terminal 400 such as the soft keys 432, 431. In alternate embodiments any suitable key or section on the touch screen display (if the device is so equipped) may be associated with the advertisement options. The advertisement options 510, 520 may allow the user to react to the additional advertising information 620 by, for example, opening a web page or calling the advertiser for more information about the offer presented by the advertisement. In alternate embodiments, any suitable functions related to the advertisement may be associated with the soft keys. These advertisement options may open a direct communication line or contact with the advertising company. If the user elects not to view the additional advertising information 620 the advertising information 610 may be removed from the display 420 (Block 665, FIG. 8B).

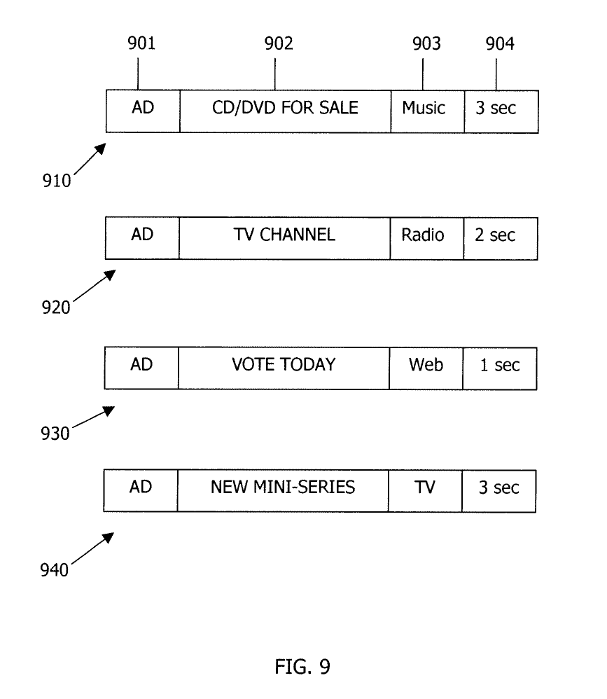

In one embodiment, the user of the mobile terminal may, for example select or activate a device function 600 such as a music player of the terminal 400 via an icon or link, such as icon 469. Advertisement information 610 (e.g. the indicator or preview) related to the advertising message(s) may be displayed on the display 420 of the device 400, for example, for a predetermined period of time (e.g. the preview period). The predetermined amount of time may be set in any suitable manner. For example, the predetermined period of time may be user definable or it may be specified in part of the advertising information received or downloaded by the terminal 400. FIG. 9 illustrates schematic representations of messages 910-940 that may be received by the terminal 400. In other embodiments the messages may be any suitable messages having any suitable content and form. Portion 901 may indicate the type of message which in this case the message type is an advertisement message. Portion 902 may indicate the type of advertising message. Portion 903 may indicate the category or context of the advertisement and portion 904 may indicate the length of time the advertisement is to be displayed to the user of the terminal 400. For example, message 910 indicates an advertisement for a CD/DVD that is associated with a music category that will be displayed for three seconds. Message 920 indicates a radio advertisement for a television channel that is associated with a radio category that will be displayed to the user for two seconds and so on. The user may use the soft keys 432, 431 or any other suitable key of the mobile terminal 400 to select the advertisement information 610 or to activate, for example, a function of the mobile terminal that displays the additional advertising information 620. If the user does not select the advertisement information 610 within the preview period the terminal 400 may present a display 630 to the user without any advertising.

Where the user selects the advertisement information 610, the additional advertising information 620 may be displayed on the display 420. When the additional advertising information 620 is displayed the user may use, for example, the soft keys 432, 431 to select the customized functions, as described above, associated with the additional advertising information 620 to obtain more information about the advertising offer (Block 680, FIG. 8B). In alternate embodiments any suitable key or press on the touch screen display (if the device is so equipped) may be utilized to activate the advertising function for display of the ad. The additional advertising information 620 may be displayed for a predetermined amount of time (e.g. the advertising period). If the user does not request more information about the ad via, for example, the soft keys 432, 431 the display 430 may be presented without any advertising (Block 690, FIG. 8B).

In another embodiment, the advertising information or a portion of the advertising information may be automatically displayed by the terminal 400 when, for example any suitable event occurs. The events may include, but are not limited to the downloading of the advertisement, the press of a key on the keypad, the receipt of a call or message, activating the terminal from an idle mode, etc. The events that automatically trigger the display of the advertisement or a portion of the advertisement may be user definable such as through a setting menu, they may be preset during manufacture or a combination thereof. In still other embodiments, information related to the advertisement may be displayed after a delay. The delay may be user settable, defined in the advertising message, or defined by a system administrator (e.g. mobile communications operator, web site operator, etc.). In alternate embodiments the delay may be specified in any suitable manner.

As described above, the user interface of the mobile terminal 400 may include a settings menu so that the user may define the amount of time the indicator or any suitable portion of the advertising information is displayed on the device. The menu of the user interfaces described herein may also include user settings for controlling the number of times the advertisements are displayed and for the types of advertisements to be displayed. For example, a user may adjust the settings so that each advertisement is displayed, for example, three times. In alternate embodiments the user may be able to specify the number of times a certain type or category of ad is displayed. For example, advertisements pertaining to sports may be displayed three times while advertisements the advertisements pertaining to traveling are displayed once. The user may also adjust the menu settings so that the advertisements are presented during a certain time period. For example, the menu setting may be adjusted so that all ads are displayed between 1:00 p.m. and 2:00 p.m. In alternate embodiments the setting may be adjusted so that, for example, music CD or DVD related ads are displayed between 1:00 p.m. and 2:00 p.m., radio related ads are displayed between 2:00 p.m. and 3:00 p.m., internet related ads are displayed between 3:00 p.m. and 4:00 p.m. and television related ads are displayed between 4:00 p.m. and 5:00 p.m. In other alternate embodiments the setting may be adjusted to associate an ad with a particular time slot, for example, an ad for a television show that starts at 7:00 p.m. may be displayed on the mobile device when or just before the show starts. In other alternate embodiments the number of times the ads are displayed and the time period the ads are display may be set via the advertising message, by the manufacturer of the mobile device or by a system administrator such as, for example, a mobile communications operator or web site operator.

The user interface may also include a menu in which the user can customize how the advertisements are presented. For example, the user may specify where the advertisement information is presented (e.g. over which icon, text, image, etc. the ad is placed) or the user may select which available customized functions may be associated with the soft keys 432, 431.

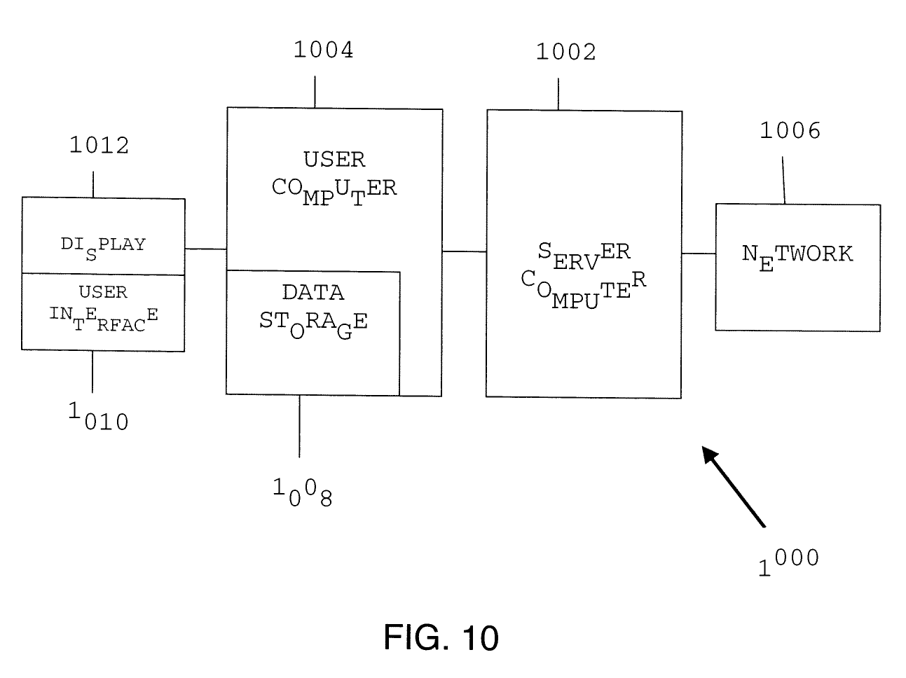

The disclosed embodiments may also include software and computer programs incorporating the process steps and instructions described above that are executed in different computers. FIG. 10 is a block diagram of one embodiment of a typical apparatus 1000 incorporating features that may be used to practice the present invention. As shown, a computer system 1002 may be linked to another computer system 1004, such that the computers 1002 and 1004 are capable of sending information to each other and receiving information from each other. In one embodiment, computer system 1002 could include a server computer adapted to communicate with a network 1006. Computer systems 1002 and 1004 can be linked together in any conventional manner including, for example, a modem, hard wire connection, or fiber optic link. Generally, information can be made available to both computer systems 1002 and 1004 using a communication protocol typically sent over a communication channel or through a dial-up connection on ISDN line. Computers 1002 and 1004 are generally adapted to utilize program storage devices embodying machine readable program source code, which is adapted to cause the computers 1002 and 1004 to perform the method steps of the present invention. The program storage devices incorporating features of the invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1002 and 1004 may also include a microprocessor for executing stored programs. Computer 1002 may include a data storage device 1008 on its program storage device for the storage of information and data. The computer program or software incorporating the processes and method steps incorporating features of the present invention may be stored in one or more computers 1002 and 1004 on an otherwise conventional program storage device. In one embodiment, computers 1002 and 1004 may include a user interface 1010, and a display interface 1012 from which features of the present invention can be accessed. The user interface 1010 and the display interface 1012 can be adapted to allow the input of queries and commands to the system, as well as present the results of the commands and queries.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
displaying at least one user interface feature on a display;
receiving at least a first information related to at least one advertisement; and
displaying the at least first information related to the at least one advertisement in place of at least one of the at least one user interface feature when the at least one user interface feature is visible on the display.

2. The method of claim 1, further comprising receiving at least a second information related to the at least one advertisement.

3. The method of claim 2, wherein the first and second information are received at the same time.

4. The method of claim 2, wherein the second information is displayed when the first information is selected by a user.

5. The method of claim 4, wherein the second information is displayed in place of the first information.

6. The method of claim 4, wherein the second information is displayed independently from the first information.

7. The method of claim 1, further comprising matching a context of the at least first information with a context of the at least one user interface feature, wherein the at least first information is displayed in place of the matching at least one user interface feature.

8. The method of claim 1, wherein the at least one user interface feature includes icons, text, graphics or symbols.

9. The method of claim 1, wherein the at least first information is received through an internet or digital communications network.

10. The method of claim 1, further comprising displaying the first information or second information related to the at least one advertisement for at least one predetermined period of time, during which at least one predetermined period a user may request information related to the at least one advertisement.

11. The method of claim 10, further comprising displaying a user interface without any advertisements after the at least one predetermined period expires.

12. The method of claim 1, wherein the device is a mobile communications terminal.

13. The method of claim 1, further comprising displaying the at least first information related to the at least one advertisement in place of at least one of the at least one user interface feature when the at least one user interface feature is selected by a user.

14. An apparatus comprising:
a display configured to display at least one user interface feature;
a receiver configured to receive at least a first information related to at least one advertisement; and
a processor configured to display the at least first information related to the at least one advertisement in place of at least one of the at least one user interface feature when the at least one user interface feature is visible on the display.

15. The apparatus of claim 14, wherein the receiver is further configured to receive at least a second information related to the at least one advertisement.

16. The apparatus of claim 15, wherein the first and second information are received at the same time.

17. The apparatus of claim 15, wherein the second information is displayed when the first information is selected by a user.

18. The apparatus of claim 17, wherein the second information is displayed in place of the first information.

19. The apparatus of claim 17, wherein the second information is displayed independently from the first information.

20. The apparatus of claim 14, wherein the processor is further configured to match a context of the at least first information with a context of the at least one user interface feature, wherein the at least first information is displayed in place of the matching at least one user interface feature.

21. The apparatus of claim 14, wherein the at least one user interface feature includes icons, text, graphics or symbols.

22. The apparatus of claim 14, wherein the at least first information is received through an internet or digital communications network.

23. The apparatus of claim 14, wherein the processor is configured to display the first information or second information related to the at least one advertisement for at least one predetermined period of time, during which at least one predetermined period a user may request information related to the at least one advertisement.

24. The apparatus of claim 23, further comprising displaying a user interface without any advertisements after the at least one predetermined period expires.

25. The apparatus of claim 14, wherein the device is a mobile communications terminal.

26. The apparatus of claim 14, wherein the processor is further configured to display the at least first information related to the at least one advertisement in place of at least one of the at least one user interface feature when the at least one user interface feature is selected by a user.

27. A computer program product comprising:
a computer useable medium having computer readable code means embodied therein for causing a computer to display at least a first information related to at least one advertisement, the computer readable code means in the computer program product comprising:
computer readable code means for causing a computer to display at least one user interface feature on a display;
computer readable code means for causing a computer to receive at least a first information related to at least one advertisement; and
computer readable code means for causing a computer to display the at least first information related to the at least one advertisement in place of at least one of the at least one user interface feature when the at least one user interface feature is visible on the display.
